(19) United States
(12) Patent Application Publication
(10) Pub. No.: US 2025/0358908 A1
(43) Pub. Date: Nov. 20, 2025

(54) INDUCTION HEATING COOKTOP

(71) Applicant: LG ELECTRONICS INC., Seoul (KR)

(72) Inventors: Hojae SEONG, Seoul (KR); Dooyong OH, Seoul (KR); Seungbok OK, Seoul (KR); Byeongwook PARK, Seoul (KR)

(73) Assignee: LG ELECTRONICS INC., Seoul (KR)

(21) Appl. No.: 18/869,584

(22) PCT Filed: May 9, 2023
(86) PCT No.: PCT/KR2023/006300

§ 371 Date: Nov. 26, 2024

(30) Foreign Application Priority Data
May 26, 2022 (KR) 10-2022-0064964

(51) Int. Cl. H05B 6/12; H05B 6/06

(52) U.S. Cl. CPC H05B 6/1209; H05B 6/062; H05B 2206/02; H05B 2213/04; H05B 2213/07

(57) ABSTRACT

An induction heating cooktop according to an embodiment of the present disclosure may include a top plate on which a cooking vessel is placed; a working coil configured to generate a magnetic field passing through the cooking vessel; an inverter configured to supply current to the working coil; a sensor configured to detect the temperature of the top plate; and a controller configured to identify a material of the cooking vessel using at least one of a change in a load impedance and a change in temperature, and determine whether the cooking vessel is in a preheated state based on at least one reference value that compares the change in the load impedance and the change in temperature, which are set differently for each material of the cooking vessel.

### TECHNICAL FIELD

The present disclosure relates to an induction heating cooktop.

### BACKGROUND

Various cooking appliances are used to heat food at home or in restaurants. In the past, gas ranges using gas as fuel were widely used, but recently, devices that heat objects to be heated, such as cooking containers such as pots, using electricity instead of gas have been popularized.

The method of heating objects to be heated using electricity is largely divided into resistance heating and induction heating. The electric resistance method is a method of heating objects to be heated by transmitting heat generated when current is passed through a metal resistance wire or a non-metallic heating element such as silicon carbide to the object to be heated (e.g., a cooking container) through radiation or conduction. In addition, the induction heating method is a method of generating eddy current in a heated object made of metal components by using a magnetic field generated around the coil when a high-frequency power of a predetermined size is applied to the coil, thereby heating the object to be heated itself.

Recently, induction heating is mostly applied to cooktops. Meanwhile, users can preheat the cooking container first before cooking food. In particular, a preheating process may be required to heat the cooking container itself in advance so that heat is evenly transferred to the food. Such preheating of the cooking container is to heat the cooking container to an appropriate temperature, and if it is heated too much, there is a risk of damage to the cooking container. In particular, if the cooking container is preheated, the food cannot be placed, and the temperature of the cooking container rises rapidly, causing the cooking container itself to be overheated.

### DETAILED DESCRIPTION

### Technical Problem

The present disclosure is to provide an induction heating cooktop that improves the above-described problem.

The present disclosure is to provide an induction heating cooktop that determines whether a cooking container is in a preheated state without separate input and preheats it to an appropriate temperature.

The present disclosure is to provide an induction heating cooktop that enables stable cooking when heating a cooking container that has no food or only a small amount of oil for preheating.

### Technical Solution

A cooktop using an induction heating method according to an embodiment of the present disclosure may include a top plate on which a cooking vessel is placed; a working coil configured to generate a magnetic field passing through the cooking vessel; an inverter configured to supply current to the working coil; a sensor configured to detect the temperature of the top plate; and a controller configured to identify a material of the cooking vessel using at least one of a change in a load impedance and a change in temperature, and determine whether the cooking vessel is in a preheated state based on at least one reference value that compares the change in the load impedance and the change in temperature, which are set differently for each material of the cooking vessel.

When the cooking vessel is in a preheated state, the controller may adjust an output to be lower than the output according to the set heat power.
when the cooking vessel is changed from a preheated state to a heated state, the controller may adjust the output to an output according to the set heat power.

The controller may determine whether the cooking vessel is in an overheated state by using at least one of the change amount of the load impedance and the change amount of the temperature after the heating state has been changed.

The controller is configured to stop the output when the cooking vessel is in an overheated state.

The controller may determine the cooking vessel is in a preheated state when the slope of the change amount of the load impedance is equal to or greater than a first preset reference value or the slope of the change amount of the temperature is equal to or greater than a second preset reference value.

The controller may determine whether the cooking vessel is in a preheated state at a time point when a preset time has elapsed after the start of heating.

The controller may set a different reference value for comparing the amount of change in the load impedance and the amount of change in the temperature according to the material of the cooking vessel.

The controller may set a different reference value for comparing the amount of change in the load impedance and the amount of change in the temperature according to the set firepower.

The controller may set a larger reference value for comparing the amount of change in the load impedance and the amount of change in the temperature as the set firepower increases, and set a smaller reference value for comparing the amount of change in the load impedance and the amount of change in the temperature as the set firepower decreases.

### Effects of the Present Invention

According to an embodiment of the present disclosure, the preheating state can be determined based on the amount of change in load impedance and the amount of change in temperature of the top plate calculated after the start of heating without adding a separate hardware configuration, so there is an advantage of being able to determine the preheating state without an increase in cost.

According to an embodiment of the present disclosure, the preheating state of the cooking container can be determined without a separate user input, and when the cooking container is in the preheating state, the output can be lowered, so that the cooking container can be preheated and heated stably.

According to an embodiment of the present disclosure, the preheating state is determined using a reference value set differently for each material of the cooking container and each firepower stage, so there is an advantage of increasing the accuracy of determining the preheating state and improving the reliability accordingly.

### BRIEF EXPLANATION OF THE DRAWINGS

FIG. 1 is a perspective view illustrating a cooktop and a cooking vessel according to an embodiment of the present disclosure.

FIG. 2 is a cross-sectional view of a cooktop and a cooking vessel according to an embodiment of the present disclosure.

FIG. 3 is a diagram illustrating a circuit diagram of a cooktop according to an embodiment of the present disclosure.

FIG. 4 is a diagram illustrating output characteristics of a cooktop according to an embodiment of the present disclosure.

FIG. 5 is a control block diagram of an induction heating type cooktop according to an embodiment of the present disclosure.

FIG. 6 is a graph measuring a change in load impedance and a change in temperature of a top plate according to a state of a cooking vessel according to an embodiment of the present disclosure.

FIG. 7 is a graph illustrating the results of measuring changes in temperature of a top plate for a predetermined time after the start of heating for cooking vessels of various materials when water is present and when empty.

FIG. 8 is a graph illustrating the results of measuring load impedance for a predetermined time after the start of heating when water is present and when empty for cooking containers of various materials according to an embodiment of the present disclosure.

FIG. 9 is a flowchart illustrating an operating method of a cooktop according to an embodiment of the present disclosure.

### BEST MODE

Hereinafter, embodiments related to the present disclosure will be described in more detail with reference to the drawings. The suffixes “module” and “part” used for components in the following description are given or used interchangeably only for the convenience of writing the specification, and do not have distinct meanings or roles in themselves.

Hereinafter, an induction heating cooktop and its operating method according to an embodiment of the present disclosure will be described. For the convenience of explanation, “induction heating cooktop” will be referred to as “cooktop.”

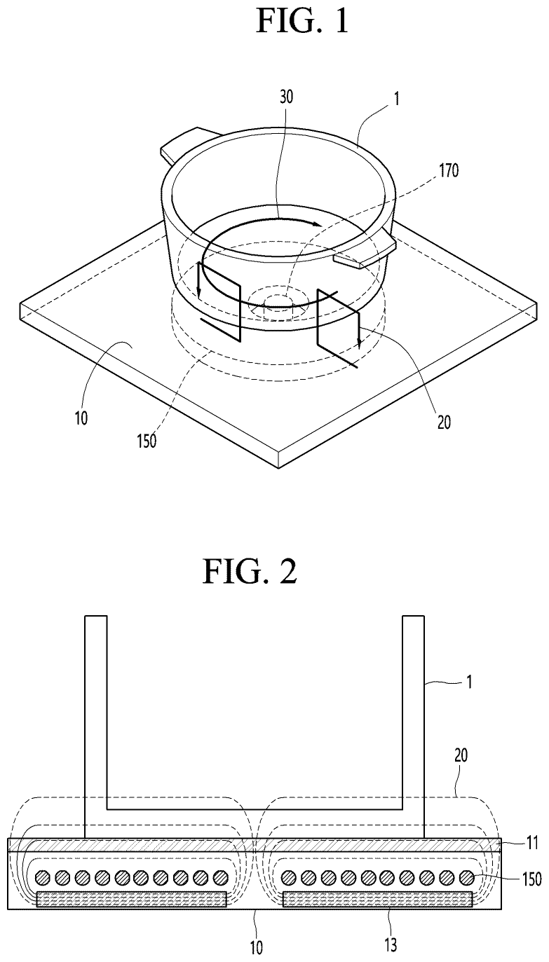

FIG. 1 is a perspective view illustrating a cooktop and a cooking vessel according to an embodiment of the present disclosure, and FIG. 2 is a cross-sectional view of a cooktop and a cooking vessel according to an embodiment of the present disclosure.

A cooking vessel 1 can be located above a cooktop 10, and the cooktop 10 can heat a cooking vessel 1 located above it. First, the method of heating the cooking vessel 1 by the cooktop 10 is explained.

As shown in FIG. 1, the cooktop 10 can generate a magnetic field 20 so that at least a part of the magnetic field passes through the cooking vessel 1. At this time, if the material of the cooking vessel 1 includes an electric resistance component, the magnetic field 20 can induce an eddy current 30 in the cooking vessel 1. This eddy current 30 heats the cooking vessel 1 itself, and this heat is conducted or radiated and transferred to the inside of the cooking vessel 1, so that the contents of the cooking vessel 1 can be cooked.

On the other hand, if the material of the cooking vessel 1 does not include an electric resistance component, eddy current does not occur. Therefore, in this case, the cooktop 10 cannot heat the cooking vessel 1.

Therefore, the cooking vessel 1 that can be heated by the cooktop 10 may be a metal vessel such as a stainless steel series or an enamel or cast iron vessel.

Next, a method for the cooktop 10 to generate a magnetic field 20 will be described.

As shown in FIG. 2, the cooktop 10 may include at least one of a top plate 11, a working coil 150, and a ferrite core 13.

The top plate 11 is where the cooking vessel 1 is placed and can support the cooking vessel 1. That is, the cooking vessel 1 may be placed on the upper surface of the top plate 11. A heating area where the cooking vessel 1 is heated can be formed on the top plate 11.

In addition, the top plate 11 can be formed of reinforced glass made of a ceramic material that synthesizes various minerals. Accordingly, the top plate 11 can protect the cooktop 10 from external impacts, etc.

In addition, the top plate 11 can prevent foreign substances such as dust from entering the inside of the cooktop 10.

The working coil 150 may be located below the top plate 11. The working coil 150 may or may not be supplied with current to generate a magnetic field 20. Specifically, the current may or may not flow to the working coil 150 depending on the on/off of the switching element inside the cooktop 10.

When current flows to the working coil 150, a magnetic field 20 is generated, and this magnetic field 20 may encounter an electric resistance component included in the cooking vessel 1 to generate an eddy current 30. The eddy current heats the cooking vessel 1, and accordingly, the contents of the cooking vessel 1 may be cooked.

In addition, the heat of the cooktop 10 may be adjusted depending on the amount of current flowing to the working coil 150. As a specific example, the more current flows through the working coil 150, the more the magnetic field 20 is generated, and accordingly, the magnetic field passing through the cooking vessel 1 increases, so that the heat power of the cooktop 10 can be increased.

The ferrite core 13 is a component for protecting the internal circuit of the cooktop 10. Specifically, the ferrite core 13 acts as a shield to block the influence of the magnetic field 20 generated from the working coil 150 or the electromagnetic field generated from the outside on the internal circuit of the cooktop 10.

For this purpose, the ferrite core 13 may be formed of a material having very high permeability. The ferrite core 13 plays a role in inducing the magnetic field flowing into the interior of the cooktop 10 to flow through the ferrite core 13 rather than being radiated. The appearance of the magnetic field generated in the working coil 150 moving by the ferrite core 13 may be as shown in FIG. 2.

Meanwhile, the cooktop 10 may further include other configurations in addition to the top plate 11, the working coil 150, and the ferrite core 13 described above. For example, the cooktop 10 may further include an insulating material (not shown) positioned between the top plate 11 and the working coil 150. That is, the cooktop according to the present disclosure is not limited to the cooktop 10 illustrated in FIG. 2.

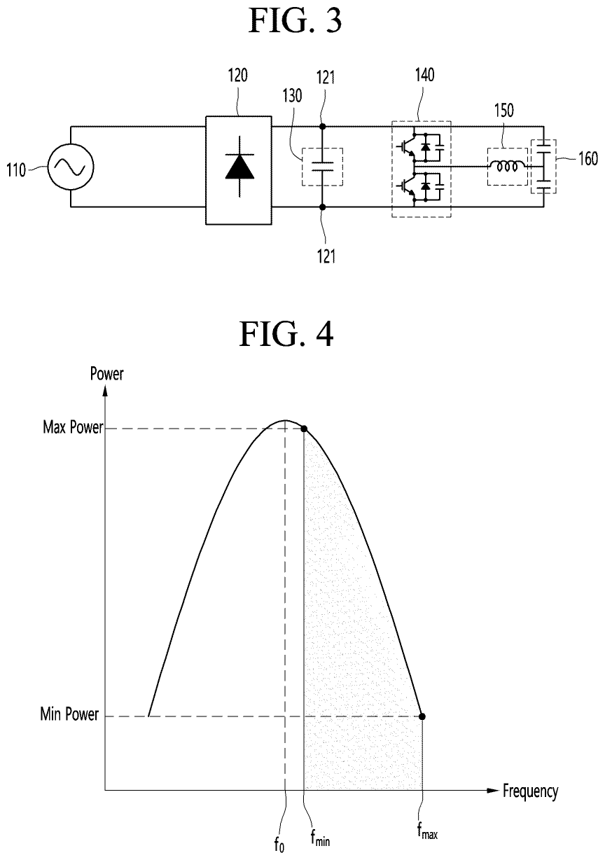

FIG. 3 is a diagram illustrating a circuit diagram of a cooktop according to an embodiment of the present disclosure.

The circuit diagram of the cooktop 10 illustrated in FIG. 3 is merely an example for convenience of explanation, and thus the present disclosure is not limited thereto.

Referring to FIG. 3, the induction heating type cooktop may include at least some or all of a power supply unit 110, a rectifier unit 120, a DC link capacitor 130, an inverter 140, a working coil 150, and a resonant capacitor 160.

The power supply unit 110 can receive external power. The power that the power supply unit 110 receives from the outside can be Alternation Current (AC) power.

The power supply unit 110 can supply AC voltage to the rectifier unit 120.

The rectifier unit 120 is an electrical device for converting AC into DC. The rectifier unit 120 converts the AC voltage supplied through the power supply unit 110 into DC voltage. The rectifier unit 120 can supply the converted voltage to the DC terminals 121.

The output terminal of the rectifier unit 120 can be connected to the DC terminals 121. The DC terminals 121 output through the rectifier unit 120 can be called a DC link. The voltage measured at both ends of the DC 121 is called the DC link voltage.

The DC link capacitor 130 acts as a buffer between the power supply 110 and the inverter 140. Specifically, the DC link capacitor 130 is used to maintain the DC link voltage converted through the rectifier 120 and supply it to the inverter 140.

The inverter 140 switches the voltage applied to the working coil 150 so that a high-frequency current flows to the working coil 150. The inverter 140 may include a semiconductor switch, and the semiconductor switch may be an Insulated Gate Bipolar Transistor (IGBT) or a Wide Band Gab (WBG) element, but this is only an example and therefore it is reasonable that it is not limited thereto. Meanwhile, the WBG element may be SiC (Silicon Carbide) or GaN (Gallium Nitride), etc. The inverter 140 drives a semiconductor switch to cause a high-frequency current to flow through the working coil 150, thereby forming a high-frequency magnetic field in the working coil 150.

The working coil 150 may or may not have current flowing depending on whether the switching element is driven. When current flows through the working coil 150, a magnetic field is generated. The working coil 150 may generate a magnetic field according to the current flow to heat the cooking appliance.

One side of the working coil 150 is connected to the connection point of the switching element of the inverter 140, and the other side is connected to the resonant capacitor 160.

The driving of the switching element is performed by a driving unit (not shown), and the switching elements are controlled by the switching time output from the driving unit, and a high-frequency voltage is applied to the working coil 150 while the switching elements operate alternately. In addition, since the on/off time of the switching elements applied by the driving unit (not shown) is gradually controlled in a compensated form, the voltage supplied to the working coil 150 changes from a low voltage to a high voltage.

The resonant capacitor 160 may be a component to act as a buffer. The resonant capacitor 160 controls the saturation voltage rise rate during the turn-off of the switching element, thereby affecting the energy loss during the turn-off time.

In the case of a cooktop 10 configured with a circuit diagram as shown in FIG. 3, the resonance frequency is determined by the inductance value of the working coil 150 and the capacitance value of the resonance capacitor 160. Then, a resonance curve is formed centered on the determined resonance frequency, and the resonance curve can represent the output power of the cooktop 10 according to the frequency band.

Next, FIG. 4 is a drawing illustrating the output characteristics of the cooktop according to an embodiment of the present disclosure.

First, the Q factor (quality factor) can be a value indicating the sharpness of resonance in a resonance circuit. Therefore, in the case of the cooktop 10, the Q factor is determined by the inductance value of the working coil 150 included in the cooktop 10 and the capacitance value of the resonance capacitor 160. The resonance curve is different depending on the Q factor. Therefore, the cooktop 10 has different output characteristics depending on the inductance value of the working coil 150 and the capacitance value of the resonant capacitor 160.

FIG. 4 illustrates an example of a resonance curve according to the Q factor. In general, the larger the Q factor, the sharper the shape of the curve, and the smaller the Q factor, the broader the shape of the curve.

The horizontal axis of the resonance curve can represent the frequency, and the vertical axis can represent the output power. The frequency at which the maximum power is output in the resonance curve is called the resonance frequency (f0).

In general, the cooktop 10 uses the frequency in the right area based on the resonance frequency (f0) of the resonance curve. In addition, the cooktop 10 may have a preset minimum and maximum operating frequency at which it can operate.

For example, the cooktop 10 may operate at a frequency corresponding to a range from the maximum operating frequency (fmax) to the minimum operating frequency (fmin). That is, the operating frequency range of the cooktop 10 may be from the maximum operating frequency (fmax) to the minimum operating frequency (fmin).

For example, the maximum operating frequency (fmax) may be the IGBT maximum switching frequency. The IGBT maximum switching frequency may mean the maximum frequency at which it can operate, considering the internal voltage and capacity of the IGBT switching element. For example, the maximum operating frequency (fmax) may be 75 kHz.

The minimum operating frequency (fmin) may be approximately 20 kHz. In this case, since the cooktop 10 does not operate at an audible frequency (approximately 16 Hz to 20 kHz), there is an effect of reducing the noise of the cooktop 10.

Meanwhile, the setting values of the maximum operating frequency (fmax) and minimum operating frequency (fmin) described above are merely exemplary and are not limited thereto.

When the cooktop 10 receives a heating command, it can determine the operating frequency according to the thermal power stage set in the heating command. Specifically, the cooktop 10 can adjust the output power by lowering the operating frequency as the set thermal power stage is higher and raising the operating frequency as the set thermal power stage is lower. That is, when the cooktop 10 receives a heating command, it can perform a heating mode in which it operates in one of the operating frequency ranges according to the set thermal power.

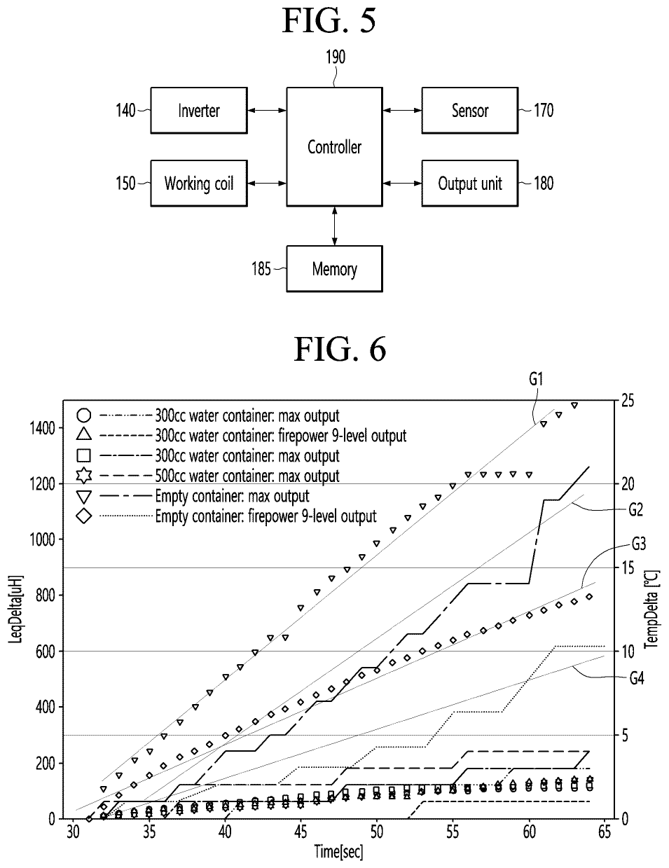

FIG. 5 is a control block diagram of a cooktop using an induction heating method according to an embodiment of the present disclosure.

An induction heating cooktop 10 using an induction heating method according to an embodiment of the present disclosure May include at least some or all of an inverter 140, a working coil 150, a sensor 170, an output unit 180, a memory 185, and a controller 190.

The inverter 140 may supply current to the working coil 150. The inverter 140 may convert direct current power rectified by the rectifier 120 into alternating current power and supply it to the working coil 150. The inverter 140 may be formed in various forms, such as a half-bridge or a full-bridge.

The working coil 150 can receive current from the inverter 140 and generate a magnetic field passing through the cooking vessel 1.

The sensor 170 can detect the temperature. The sensor 170 can be a temperature sensor for directly or indirectly detecting the temperature of the cooking vessel 1. The sensor 170 is a sensor positioned at the topmost part of the cooktop 10 and can be a top sensor.

The sensor 170 can be positioned in the center of the working coil 150. The sensor 170 can be positioned to directly or indirectly contact the top plate 11. For example, the sensor 170 can be positioned to contact the lower surface of the top plate 11 and detect the temperature of the top plate 11.

The sensor 170 can calculate the temperature of the cooking vessel 1 through the top plate 11. Specifically, since the heat of the cooking vessel 1 is transferred to the top plate 11, the sensor 170 can indirectly calculate the temperature of the cooking vessel 1 by measuring the temperature of the top plate 11.

The output unit 180 can output information related to the operation of the cooktop 10. The output unit 170 can include audio (not shown) for audibly outputting information related to the cooktop 10 or a display (not shown) for visually outputting information related to the cooktop 10.

The output unit 180 can output a notification indicating the status of the cooking vessel 1. For example, the output unit 170 can output a notification indicating that the cooking vessel 1 is in a preheating state, a notification indicating that it is in a heating state, or a notification indicating that it is in an overheating state.

The memory 185 can store data related to the operation of the cooktop 10. For example, the memory 185 can store identification data necessary to determine the preheating state of the cooking vessel 1.

The controller 190 can control each component provided in the cooktop 10, such as the inverter 140, the working coil 150, the sensor 170, and the output unit 180.

Meanwhile, the controller 190 can determine the state of the cooking vessel 1. Specifically, the controller 190 can determine the state of the cooking vessel 1 as one of the preheating state, the heating state, and the overheating state.

The preheating state may refer to a state in which the cooking container 1 is first heated to a certain degree before cooking food. The preheating state may refer to a state in which there is no food inside the cooking container 1 or only a small amount of oil.

The heating state may refer to a state in which food is being heated. The heating state may refer to a state in which food exists inside the cooking container 1.

The overheating state may refer to a state in which food is excessively heated and is about to burn or is about to burn. The overheating state may refer to a state in which most of the moisture inside the cooking container 1 has evaporated.

The controller 190 may determine the state of the cooking container 1 based on the load impedance and the temperature of the top plate 11 detected by the sensor 170 while heating the cooking container 1. The sensor 170 detecting the temperature of the top plate 11 has already been described above, and the load impedance will be described below.

The load impedance can be calculated using the following Math FIG. 1.

$$\frac{1}{ω} \sqrt{{Z}^{2} - {R}_{eq}^{2}} + \frac{1}{{ω}^{2} {C}_{eq}} \qquad [ Math Figure 1 ]$$

In the above Math FIG. 1, ω [rad/s] is 2πf, and f may be the operating frequency. And, z[Ω] is 2·Vᵢₙ/(π·Iᵣₘₛ), R [Ω] is P/Iᵣₘₛ², Iᵣₘₛ [A] is Iₚₑₐₖ/2, Iₚₑₐₖ [A] is 0.0049·I_{ADC}−10.084, and I_{ADC} is the current flowing through the working coil 150, which may vary depending on the set fire power stage or the type of the cooking vessel 1. C may be the capacitance of the resonant capacitor.

However, Math FIG. 1 is only an example. That is, the controller 190 may calculate the load impedance using a method other than Math FIG. 1.

Meanwhile, the load impedance and the temperature of the top plate 11 illustrate different characteristics depending on the state of the cooking vessel 1, and the state of the cooking vessel 1 can be determined using these characteristics.

Next, referring to FIG. 6, the characteristics of the load impedance and the temperature characteristics of the top plate 11 according to the state of the cooking vessel 1 are described.

FIG. 6 is a graph measuring the amount of change in the load impedance and the amount of change in the temperature of the top plate according to the state of the cooking vessel according to an embodiment of the present disclosure.

Specifically, FIG. 6 illustrates the change in load impedance and the change in temperature of the upper plate 11 over time while heating at maximum output or 9-stage power output for a container containing 300 cc of water, a container containing 500 cc of water, and an empty container. Each point shown in FIG. 6 represents the change in load impedance, and the dashed line represents the change in temperature of the upper plate 11. Each of the change in load impedance and the change in temperature of the upper plate 11 may be calculated in units of 1 second.

Looking at each point and dashed line shown in FIG. 6, it can be confirmed that the change in load impedance is less than about 300 [uH] and the change in temperature of the upper plate 11 is less than 5[° C.] for about 65 seconds after the start of heating for a container containing 300 cc or 500 cc of water.

Meanwhile, when the empty container is heated at maximum output, it can be confirmed that the change in load impedance reaches about 1400 [uH] for about 65 seconds after the start of heating, and that the change in load impedance reaches about 800 [uH] when heated at level 9 of the thermal power output. And, when the empty container is heated at maximum output, it can be confirmed that the change in temperature of the upper part 11 reaches about 20[° C.] for about 65 seconds after the start of heating, and that the change in temperature of the upper part 11 reaches about 10[° C.] when heated at level 9 of the thermal power output.

That is, in the case of an empty container, it can be confirmed that the change in load impedance and the change in temperature of the upper part 11 increase rapidly for about 65 seconds after the start of heating, compared to the case of a container containing 300 cc or 500 cc of water.

In summary, when the cooking vessel 1 is unloaded (including cases where there is no food or only a small amount of oil), it can be confirmed that the slopes for the change in load impedance and the change in temperature of the top plate 11 are very steep, and this may be a phenomenon that occurs because all energy according to the output is transferred to the cooking vessel 1 when there is no load.

Therefore, the cooktop 10 according to the present disclosure can identify whether the cooking vessel 1 is empty or not based on at least one of the change in load impedance and the change in temperature of the top plate 11 for a predetermined time after the start of heating. And, since the heating of an empty container immediately after the start of heating is mostly for the purpose of preheating, and the heating of a container containing food immediately after the start of heating is mostly for the purpose of heating the food, the cooktop 10 according to the present disclosure can determine whether the cooking container 1 is in a preheated state by using at least one of the change in load impedance and the change in temperature of the top plate 11 for a predetermined time after the start of heating. Meanwhile, the cooking container 1 being detected as an empty container after the start of heating and after already passing the heating state may be in an overheated state in which all moisture inside the cooking container 1 has evaporated due to continued overheating even after the food is heated.

The cooktop 10 according to the embodiment of the present disclosure may store identification data for determining whether the cooking vessel 1 being heated is in a preheating state or a heating state. For example, the identification data may include at least one reference value that serves as a criterion for comparing the amount of change in load impedance and the amount of change in temperature of the top plate 11, and this reference value may be set based on the slope of each trend line (G1) (G2) (G3) (G4) after an experiment that produces trend lines (G1) (G2) (G3) (G4) that represent the amount of change in load impedance and the amount of change in temperature of the top plate 11 while heating an empty vessel with maximum output and outputs of various heat stages.

The slope of each trend line (G1) (G2) (G3) (G4) may serve as a criterion value that serves as a comparison target for determining whether the cooking vessel 1 is in a preheating state or a heating state.

However, since these reference values vary depending on the material of the cooking vessel 1, the reference values can be stored in the memory 185 for each material of the cooking vessel 1.

In addition, since the material of the cooking vessel 1 is required to be distinguished, the cooktop 10 can identify the material of the cooking vessel 1 by using at least one of the temperature change amount and the load impedance of the top plate 10.

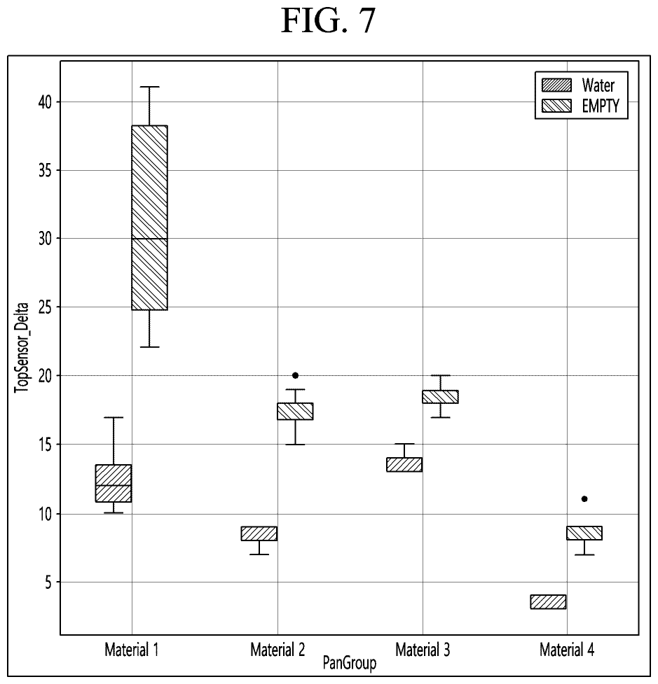

FIG. 7 is a graph illustrating the results of measuring the temperature change amount of the top plate for a predetermined time after the start of heating for cooking vessels of various materials when water is present and when it is empty according to an embodiment of the present disclosure.

In the cooking vessel of the first material, when filled with water, the temperature change of the upper part 10 is measured to be about 10 to 18[° C.], but when empty, the temperature change of the upper part 10 is measured to be about to 42[° C.]. In the cooking vessel of the second material, when filled with water, the temperature change of the upper part 10 is measured to be about 7 to 9[° C.], but when empty, the temperature change of the upper part 10 is measured to be about 15 to 19[° C.]. In the cooking vessel of the third material, when filled with water, the temperature change of the upper part 10 is measured to be about 13 to 15[° C.], but when empty, the temperature change of the upper part 10 is measured to be about 18 to 20[° C.]. It can be confirmed that the temperature change of the top plate 10 of the fourth material cooking vessel is measured as about 3 to 4[° C.] when filled with water, but is measured as about 7 to 9[° C.] when empty.

That is, it can be confirmed that the temperature change of the top plate 10 is measured differently for all container materials when filled with water and when empty. That is, regardless of the container material, the temperature change of the top plate 10 measured for a predetermined time after the start of cooking of a cooking vessel 1 filled with water is different from the temperature change of the top plate 10 measured for a predetermined time after the start of cooking of an empty cooking vessel 1.

Therefore, when the cooktop 10 identifies the container material, it can measure the temperature change of the top plate 10 of the container of the corresponding material for a predetermined time after the start of heating, and determine whether the corresponding cooking vessel 1 is in a preheated state or a heated state.

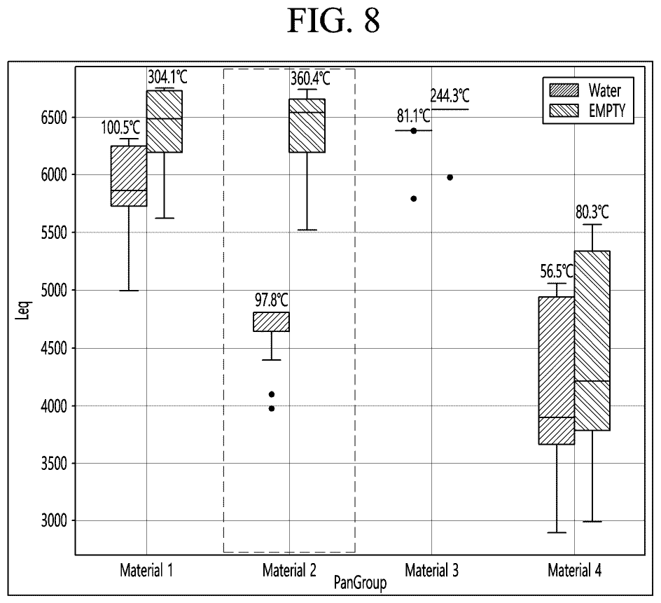

FIG. 8 is a graph illustrating the results of measuring load impedance for a predetermined time after the start of heating for cooking containers of various materials according to an embodiment of the present disclosure when water is present and when the cooking container is empty.

It can be confirmed that the load impedance of the cooking container of the first material is measured to be about 5000 to [uH] when filled with water, but is measured to be about 5600 to 6700 [uH] when empty. It can be confirmed that the load impedance of the cooking container of the second material is measured to be about 4400 to 4700 [uH] when filled with water, but is measured to be about 5550 to 6600 [uH] when empty. It can be confirmed that the load impedance of the cooking vessel of the third material is measured as approximately 6400 [uH] when filled with water, but approximately 5600 to 6650 [uH] when empty. The load impedance of the cooking vessel of the fourth material is measured as approximately 2900 to 5100 [uH] when filled with water, but approximately 2990 to 5600 [uH] when empty.

That is, it can be confirmed that the load impedance is measured differently when filled with water and when empty for the second material. That is, the load impedance measured only for the cooking vessel 1 of the second material for a predetermined time after the start of cooking is different from the load impedance measured for the empty cooking vessel 1 for a predetermined time after the start of cooking.

Therefore, when the cooktop 10 identifies the cooking vessel 1 of the second material, it can measure the load impedance for a predetermined time after the heating start for the cooking vessel 1 to determine whether the cooking vessel 1 is in a preheating state or a heating state. In other words, the controller 190 can determine whether the cooking vessel 1 is in a preheating state only with the load impedance for a specific material container such as the second material.

Meanwhile, FIG. 8 illustrates the maximum measured temperature of the top plate 11 when the cooking vessel of each material is filled with water and when it is empty. When the cooking vessel 1 of the second material is empty, it is overheated to 360.4° C., but the rest are lower than this, so it can be confirmed that the preheating state identification of the cooking vessel 1 of the second material is most important. For the cooking vessel 1 of such material, it can be determined whether the cooking vessel 1 is in a preheating state by considering the load impedance.

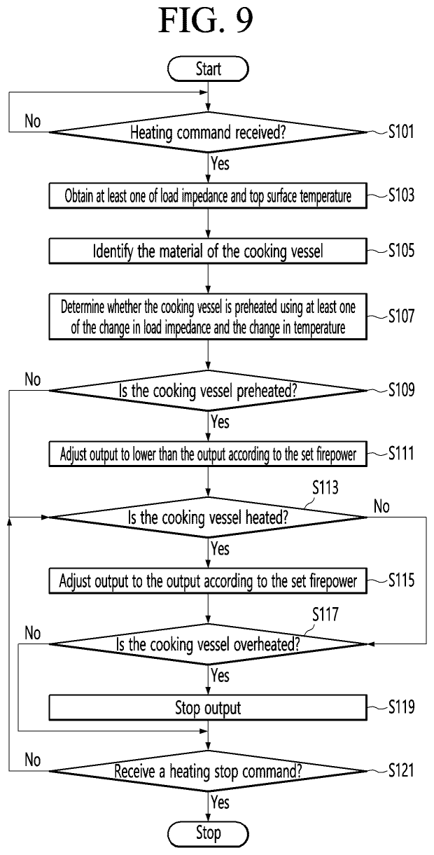

FIG. 9 is a flowchart illustrating an operation method of a cooktop according to an embodiment of the present disclosure.

The controller 190 can determine whether a heating command is received (S101).

When the controller 190 receives a heating command, the controller 190 can obtain at least one of the load impedance and the temperature of the top plate 11 (S103).

The controller 190 can obtain the load impedance and the temperature of the top plate 11 every second, and calculate the amount of change in the load impedance and the amount of change in the temperature of the top plate 11. For example, the controller 190 can calculate the amount of change in the load impedance and the amount of change in the temperature of the top plate 11 every second.

In addition, the controller 190 can identify the material of the cooking vessel 1 (S105).

The controller 190 can determine which of the first to fourth materials the cooking vessel 1 corresponds to. For example, the first material may be stainless steel, the second material may be enamel, the third material may be glass, and the fourth material may be enamel cast iron, but this is only an example and is not limited thereto. In addition, the number of material types may be less than or more than four.

Meanwhile, the order of steps S103 and S105 may be changed.

The controller 190 may determine whether the cooking vessel 1 is in a preheated state by using at least one of the change in load impedance and the change in temperature of the top plate 11 (S107).

The cooktop 10 may store reference values for each material of the cooking vessel in the memory 185, etc. That is, the controller 190 can set different reference values for comparing the change in load impedance and the change in temperature of the top plate 11 depending on the material of the cooking vessel 1.

The controller 190 may determine whether the cooking vessel 1 is in a preheated state by comparing at least one of the change in load impedance and the change in temperature of the top plate 11 with the reference value according to the material of the cooking vessel 1.

The controller 190 can determine whether the cooking vessel 1 is in a preheating state when a preset time has elapsed after the start of heating. At this time, the preset time May be 1 minute, but this is only an example and is not limited thereto. However, the controller 190 can set the preset time to a time within 5 minutes after the start of heating. This is because it is rare for the cooking vessel 1 to be preheated for more than 5 minutes in general.

As a specific example, identification data in which the reference value of the load impedance change corresponding to the first material is set as the first reference value and the reference value of the temperature change of the top plate 11 corresponding to the first material is set as the second reference value may be stored in the memory 185. The controller 190 calculates the amount of change in the load impedance and the amount of change in the temperature of the top plate 11 for a preset period of time after the start of heating upon receiving the heating command, and if the slope of the amount of change in the load impedance is greater than or equal to a preset first reference value or the slope of the amount of change in the temperature of the top plate 11 is greater than or equal to a preset second reference value at the time when the preset period of time has elapsed after the start of heating, the cooking vessel 1 can be determined to be in a preheated state.

Meanwhile, according to an embodiment, the controller 190 can set different reference values for comparing the amount of change in the load impedance and the amount of change in the temperature of the top plate 11 according to the set fire power.

Here, the set fire power may mean a fire power stage set by the user at the time of the heating command. The firepower stages are divided into stages 1 to 10, and the larger the number, the higher the output firepower stage, and stage 10 may represent the maximum firepower stage, but this is only an example, and it is reasonable not to be limited thereto.

This is because the larger the firepower, the greater the change in load impedance and the change in temperature of the upper plate 11. That is, the controller 190 may set a reference value for comparing the change in load impedance and the change in temperature of the upper plate 11 to be large as the set firepower is large, and may set a reference value for comparing the change in load impedance and the change in temperature of the upper plate 11 to be small as the set firepower is small. For example, when the set thermal power is 9 levels, the reference value for the amount of change in the load impedance is the first reference value, and the reference value for the amount of change in the temperature of the upper plate 11 is the second reference value. When the set thermal power is 1 level, the reference value for the amount of change in the load impedance may be a third reference value that is smaller than the first reference value, and the reference value for the amount of change in the temperature of the upper plate 11 may be a fourth reference value that is smaller than the second reference value.

In summary, the controller 190 can set different reference values for comparing the change in load impedance and the change in temperature of the top plate 11 according to the material and set fire power of the cooking container 1. In this way, as the standard for determining the preheating state of the cooking container 1 becomes more precise, the accuracy of determining the preheating state increases and reliability is improved.

If the controller 190 determines that the cooking container 1 is in a preheating state (S109), it can adjust the output to be lower than the output according to the set fire power (S111).

According to one embodiment, if the controller 190 determines that the cooking container 1 is in a preheating state, it can control the inverter 140 so that the cooking container 1 is heated with the preset preheating output (for example, the output corresponding to the 5-stage fire power stage).

According to another embodiment, if the controller 190 determines that the cooking vessel 1 is in a preheated state, the controller 190 can control the inverter 140 so that the cooking vessel 1 is heated with an output corresponding to a firepower that is one level lower than the set firepower according to the heating command.

That is, there may be various ways for the controller 190 to adjust the output to a lower level when the cooking vessel 1 is determined to be in a preheated state.

Meanwhile, if the controller 190 is not determined to be in a preheated state (S109), the controller 190 can determine whether the cooking vessel 1 is in a heated state (S113).

If the controller 190 determines that the cooking vessel is in a heated state, the controller 190 can adjust the output to an output according to the set firepower (S115).

That is, if the cooking vessel 1 is changed from a preheated state to a heated state, the controller 190 can adjust the output to an output according to the set heat power.

If the cooking vessel 1 is not determined to be in a heated state, the controller 190 can determine whether the cooking vessel 1 is in an overheated state (S117).

The controller 190 can determine whether the cooking vessel 1 is in an overheated state by using at least one of the change in load impedance and the change in temperature of the top plate 11 after the change in the heated state.

If the controller 190 determines that the cooking vessel 1 is overheated, it can stop the output (S119).

If the controller 190 determines that the cooking vessel 1 is overheated, it can control the inverter 140 to stop the output.

Meanwhile, the method for determining the overheated state may be the same as the method for determining whether the cooking vessel 1 is in a preheated state in step S107. That is, when determining the overheated state, at least one of the change in the load impedance and the change in the temperature of the top plate 11 may be compared with a preset reference value to determine the overheated state. That is, the controller 190 determines that the cooking container 1 is in a preheated state if at least one of the change in load impedance and the change in temperature of the top plate 11 exceeds a preset reference value within a preset time after the start of heating, and determines that the cooking container 1 is in a heated state, and if at least one of the change in load impedance and the change in temperature of the top plate 11 exceeds a preset reference value after determining that the cooking container 1 is in a heated state, the cooking container 1 can be determined to be in an overheated state.

If the controller 190 does not determine that the cooking container 1 is in an overheated state, it can determine whether a heating termination command has been received (S119).

If the controller 190 receives a heating termination command, it can terminate the operation. On the other hand, if the controller 190 does not receive a heating termination command, it can determine again whether the cooking container 1 is in a heated state.

According to the embodiment of the present disclosure, the controller 190 determines the state of the cooking vessel 1 as a preheating state, a heating state, or an overheating state without a separate user input, and adjusts the output according to the determined state, thereby enabling stable operation.

The above description is merely an example of the technical idea of the present disclosure, and those with common knowledge in the technical field to which the present disclosure belongs may make various modifications and variations without departing from the essential characteristics of the present disclosure.

Therefore, the embodiments disclosed in the present disclosure are not intended to limit the technical idea of the present disclosure, but to explain it, and the scope of the technical idea of the present disclosure is not limited by these embodiments.

The scope of protection of the present disclosure should be interpreted by the claims below, and all technical ideas within the equivalent scope should be interpreted as being included in the scope of rights of the present disclosure.

1. A cooktop of the induction heating method comprising:
a top plate on which a cooking vessel is placed;
a working coil configured to generate a magnetic field passing through the cooking vessel;
an inverter configured to supply current to the working coil;
a sensor configured to detect the temperature of the top plate; and
a controller configured to identify a material of the cooking vessel using at least one of a change in a load impedance and a change in temperature, and determine whether the cooking vessel is in a preheated state based on at least one reference value that compares the change in the load impedance and the change in temperature, which are set differently for each material of the cooking vessel,
wherein the controller, when the cooking vessel is in a preheated state, is configured to adjust an output to be lower than the output according to the set heat power.

2. The cooktop according to claim 1, wherein the controller, when the cooking vessel is changed from a preheated state to a heated state, is configured to adjust the output to an output according to the set heat power.

3. The cooktop according to claim 1, wherein the controller is configured to determine whether the cooking vessel is in an overheated state by using at least one of the change amount of the load impedance and the change amount of the temperature after the heating state has been changed.

4. The cooktop according to claim 1, wherein the controller is configured to stop the output when the cooking vessel is in an overheated state.

5. The cooktop according to claim 1, wherein the controller is configured to determine the cooking vessel is in a preheated state when the slope of the change amount of the load impedance is equal to or greater than a first preset reference value or the slope of the change amount of the temperature is equal to or greater than a second preset reference value.

6. The cooktop according to claim 1, wherein the controller is configured to determine whether the cooking vessel is in a preheated state at a time point when a preset time has elapsed after the start of heating.

7. The cooktop according to claim 1, wherein the controller is configured to set a different reference value for comparing the amount of change in the load impedance and the amount of change in the temperature according to the set firepower.

8. The cooktop according to claim 1, wherein the controller is configured to set a larger reference value for comparing the amount of change in the load impedance and the amount of change in the temperature as the set firepower increases, and set a smaller reference value for comparing the amount of change in the load impedance and the amount of change in the temperature as the set firepower decreases.

9. The cooktop according to claim 1, wherein the controller is configured to regulate the output to a preset preheating output when the cooking vessel is in a preheating state.

10. The cooktop according to claim 1, wherein the controller is configured to regulate the output to an output corresponding to a firepower that is one level lower than the output according to the set firepower.
